(19) United States
(12) Patent Application Publication
(10) Pub. No.: US 2008/0115402 A1
(43) Pub. Date: May 22, 2008

(54) Fish Decoy and Lure

(76) Inventor: Jeremy Helmin, Rice, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(21) Appl. No.: 11/943,173

(22) Filed: Nov. 20, 2007

Related U.S. Application Data
(60) Provisional application No. 60/866,454, filed on Nov. 20, 2006.

(51) Int. Cl. A01K 85/00

(52) U.S. Cl. 43/42

(57) ABSTRACT

This document discusses, among other things fishing apparatus including a front portion, a rear portion pivotably coupled to front portion, and a trailing cup-shaped member pivotably coupled to the rear portion and rotationally restricted relative to the rear portion, wherein movement of water over the cup-shaped member causes the cup-shaped member to rock side-to-side and causes the rear portion to pivot relative to the front portion of the fishing apparatus to simulate the swimming action of a fish or other animal.

This application claims the benefit of U.S. Provisional Patent Application No. 60/866,454, filed Nov. 20, 2006, the content of which is herein incorporated by reference.

### TECHNICAL FIELD

This patent document pertains generally to fish decoys, and more particularly, but not by way of limitation, to fishing decoys having fish-like action.

### BACKGROUND

Fisherman sometimes use a fish decoy or a fish lure to attract fish. For example, ice fisherman sometimes use a fish decoy in a ice fishing hole to attract large fish such as Northern pike (“Northern”) toward the ice fishing hole. Where spearing is permitted, a decoy is sometimes used to attract a fish toward the hole, giving the fisherman an opportunity to spear the fish.

### SUMMARY

An example fishing apparatus includes a front portion, a rear portion pivotably coupled to front portion, and a trailing cup-shaped member pivotably coupled to the rear portion. The trailing cup-shaped member is rotationally restricted relative to the rear portion. Movement of water over the cup-shaped member causes the cup-shaped member to rock side-to-side and causes the rear portion to pivot relative to the front portion of the fishing apparatus.

In another example, a fishing apparatus includes a jointed decoy body, a coupling member coupled to the decoy body, and a spinner blade coupled to the coupling member in a manner that allows the spinner blade to rock axially relative to the decoy body but does not allow full rotation of the spinner blade.

In another example, a fish decoy includes a head portion, a tail portion pivotably coupled to the head portion, an eye connected to the tail portion, a deep-cup spinner blade, and a ring extending through the eye and through the spinner blade. When the fish decoy is moved through water, the spinner blade rocks back and forth, causing the tail portion to pivot relative to the head portion to simulate the swimming action of a fish.

### BRIEF DESCRIPTION OF THE DRAWINGS

FIG. 1 is a perspective view of a fishing apparatus including a spinner blade coupled to a body.

FIG. 2 is a rear view showing a spinner blade coupled to a ring and a connector in a cup washer.

FIG. 3 is an enlarged top view of the spinner blade of FIG. 1 coupled to the body of the fishing apparatus.

FIG. 4 is a side view of a spinner blade coupled to a body of a fishing apparatus.

FIG. 5 shows an example cup washer.

FIG. 6 is a rear view showing a spinner blade coupled to a connector in a cup washer.

FIG. 7 is a partially cut-away top view showing a stable-type coupling arrangement of a spoon to a tail.

FIG. 8 is a side view of a fishing apparatus illustrating flow of water over the spinner blade.

FIG. 9 is a top view of a fishing apparatus illustrating jointed swimming-like action of the apparatus.

FIG. 10 is a top view of an ice hole showing the apparatus and a fish.

FIG. 11 is a side view that shows an example apparatus including fish hooks.

### DETAILED DESCRIPTION

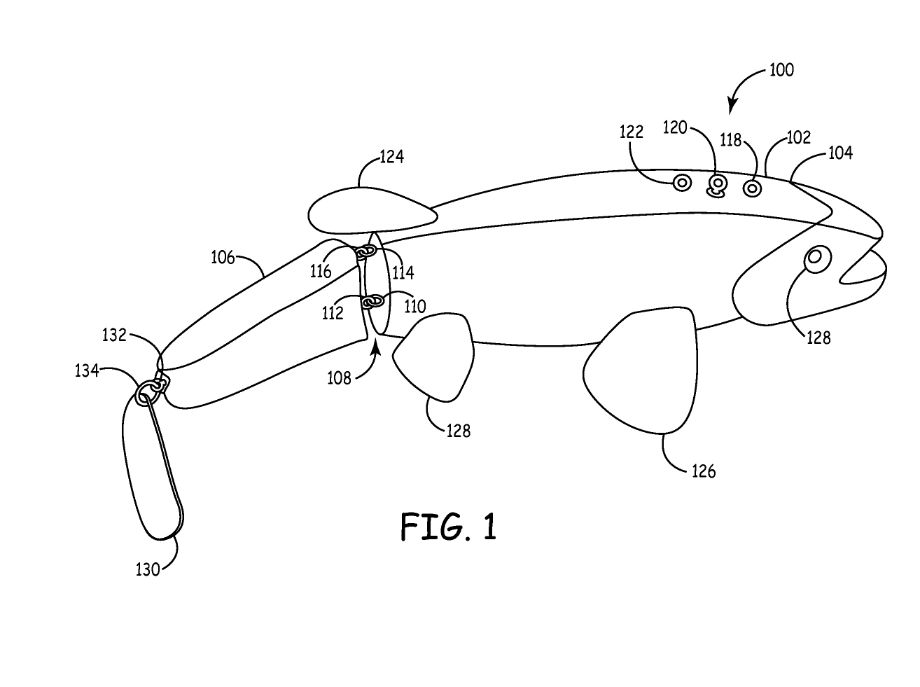

Referring now to FIG. 1, an example fishing apparatus 100 includes a body 102 and a spinner blade 130 coupled to the body. The spinner blade 130 is coupled to the body in a manner that allows the spinner blade 130 to rock side-to-side with respect to the body 102, but does not allow the spinner blade to spin. In water, the apparatus provides a jointed, fish-like swimming action.

In contrast to a free-rotating spinner blade arrangement, the apparatus restricts rotational movement of the spinner blade—in an example apparatus, the spinner blade can rotate only about ¼ turn in either direction from a neutral, horizontal position. When water flows over the fishing apparatus 100, the spinner blade 130 rocks laterally roughly horizontal to the body, causing the tail to pivot, which simulates the movement of a fish.

In the example shown in FIG. 1, the body 102 includes a front head portion 104 and a rear tail portion 106 pivotably coupled to the head portion. The spinner blade 130 causes the tail portion 106 to pivot relative to the head portion 104. The fishing apparatus 100 can be used as a decoy to attract fish such as Northern pike toward an ice fishing hole. The jointed side-to-side action of the decoy simulates the swimming motion of a fish, such as a perch or other bait-fish.

Referring again to FIG. 1, a hinge system 108, for example, can be used to pivotably couple the head portion 104 to the tail portion 106. In FIG. 1, the hinge system 108 includes a lower set of interlocking rings 110, 112 and an upper set of interlocking rings 114, 116. In an example, rings 110, 114 are screw eyes connect to the head portion 104 of the body 102, and rings 112, 116 are hooks that are bent closed around eyes 110, 114. In another example, a piano-type hinge is used to couple the head portion to the body. In another example, the body has two or more hinge joints and three or more jointed body portions.

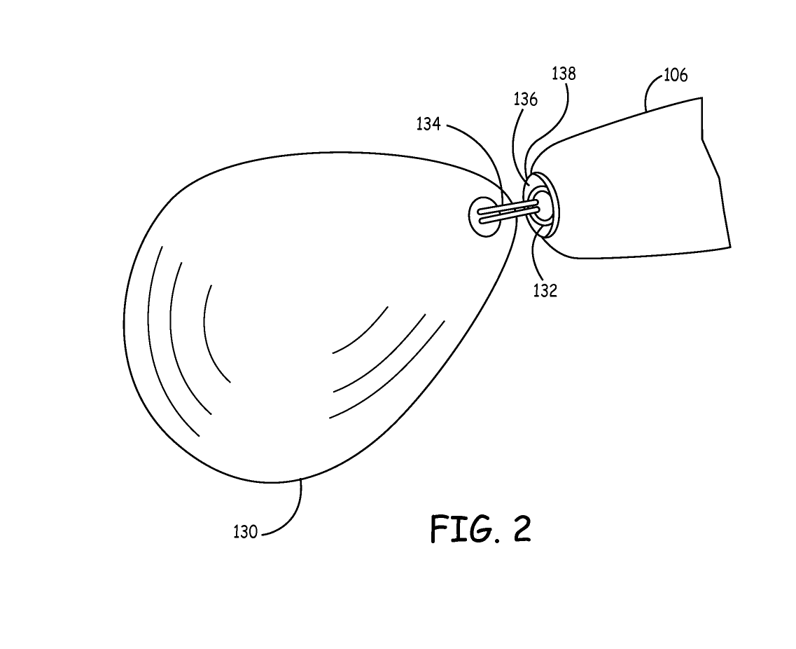

In the example shown in FIG. 1, the spinner blade 130 is coupled to the tail portion 106 of the body with an eye 132 and a ring 134. FIGS. 2, 3, and 4 respectively show enlarged, top, rear, and side views of the spinner blade 130, eye 132, ring 134, and the tail portion 106 of the body. The eye 132 is positioned in a recessed portion 136 of the body.

In an example, the eye 132 is a threaded screw eye. In an example, the screw eye is ½ inch long, has an outside diameter of about 0.18 inch, and an inside diameter of about 0.08 inch. In other examples, the eye is glued or otherwise adhered to the body, or the eye is integrally formed into the body. In an example, the screw eye is glued into position to prevent rotation of the screw. In another example, a staple-type connection could is used instead of a screw connection, and the ring 134 extends through a portion of a staple connector. In another example, a bolt connector is used to connect a bracket to the body, and the ring extends through an opening in the bracket. In another example, the body 102 include molded geometry formed to include an orifice for coupling to a ring, wire, spinner blade, or the like.

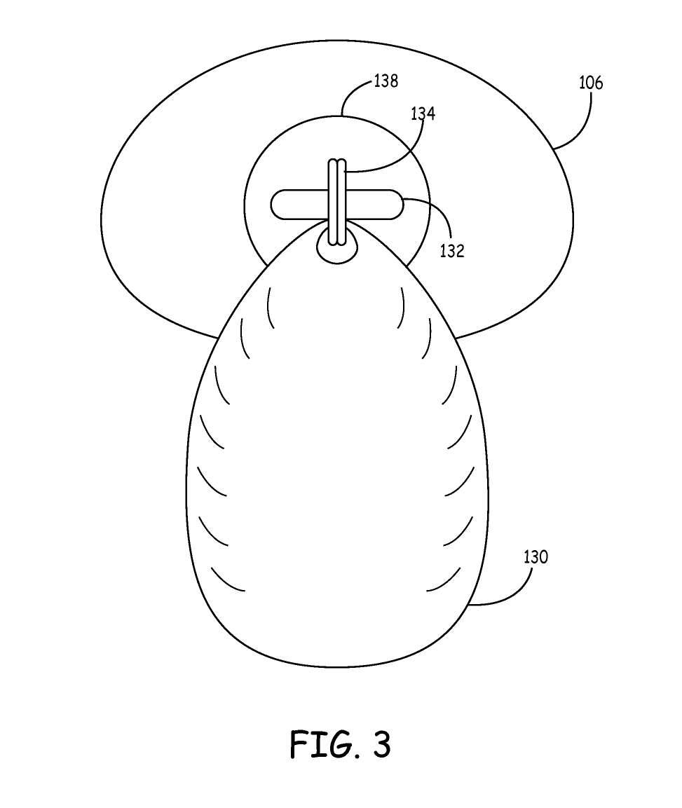

In FIGS. 2 and 3, the ring 134 is shown to be a split ring, similar to the type of ring that is commonly used to carry car keys. In an example, the split ring has an outer diameter of about 5/16 and an inner diameter of about ¼ inch. In an example, a # 3 split ring is used. In other examples, the split ring is a # 1, #2, or # 4 split ring. In another example, a looped wire is used instead of a split ring.

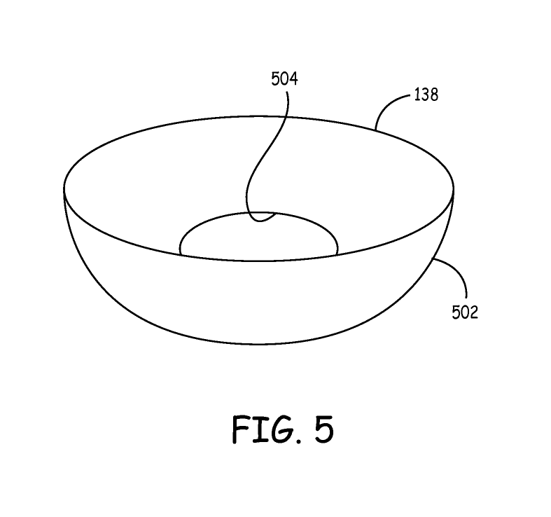

Optionally, a cup washer 138 is secured in the recessed portion 136 of the body. The cup washer 138 reduces wear caused by the ring 134 against the body. The cup washer also prevents the spinner blade from fouling up, i.e. prevents the blade from getting twisted or stuck. An example cup washer 138 is shown in FIG. 5. The cup washer has a peripheral wall 502 and a portions defining a hole 504. In one configuration, a standard cup washer is used. In an example, a 5/16 inch cup washer is used. In an example, the bottom of the 5/16 cup washer is flattened to allow the washer to seat securely against the bottom of the recessed portion 136 of the body.

Referring again back to FIGS. 1-4, in an example, the head portion 104 of the body 102 is about 6 inches long, about 1 inches wide, and about 1⅞ inches high, the tail portion 106 of the body 102 is about 2½ inches long, about ¾ inches wide, and about 3/16 inches high. Other sizes are possible. In an example with these dimensions, the spinner blade is a deep-cup Colorado # 7 (available at CABELA'S). A Colorado deep-cup #7 spinner blade is about 2 inches long, about 1 7/16 inches wide, and about ⅛ inch deep. The deep cup spinner blade captures more water and thus provides more action than a shallow spinner blade. In other examples, a smaller or larger spinner blade is used, such as a deep-cup Colorado # 6 or # 8 or larger if available. The spinner blade size is typically proportional to the size of the body. For example, for the example dimensions provided above, the length of the Colorado #7 spinner is about 20-25% of the sum of the lengths of the head portion 104 and the tail portion 106. Apparatus having substantially larger body dimensions will generally work better with a larger spinner blade, and examples having substantially smaller dimensions will generally work better with a smaller spinner blade.

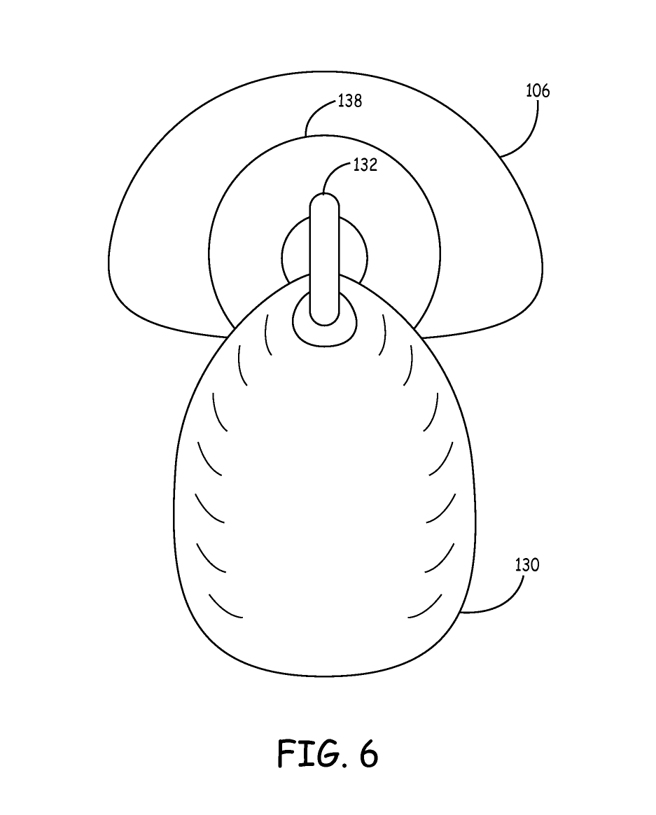

FIG. 6 shows an alternate arrangement in which the spinner blade 130 is coupled to a connector such as a screw eye 132 which is coupled to the tail portion. In this arrangement, the split ring is omitted.

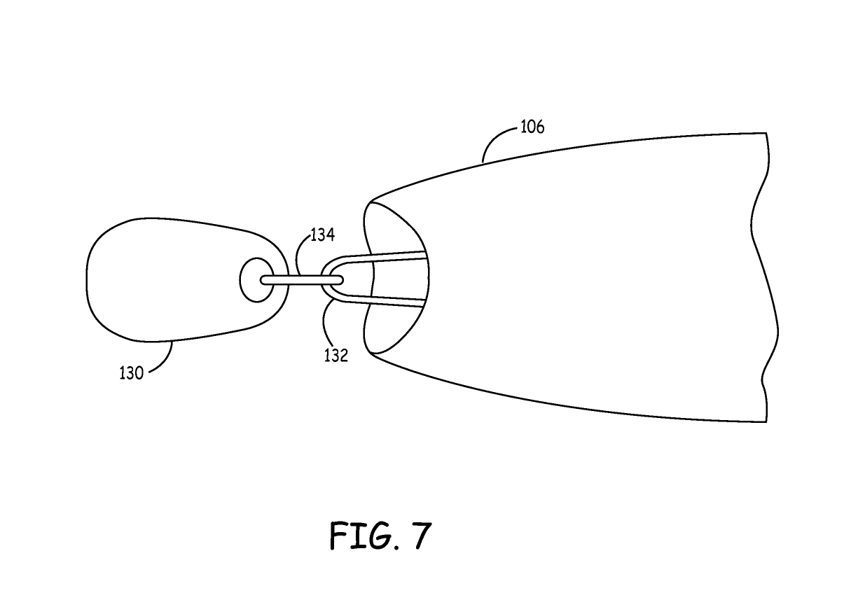

FIG. 7 shows an example where a staple connection is used instead of a screw eye. The tail portion 106 of the fish is shown cut-away to reveal legs of a staple member 702 protruding into the tail portion 106 of the apparatus. The split ring 134 is coupled to the staple member 702 and the spinner blade is coupled to the split ring 134. In another example, the spinner blade 130 is coupled directly to the staple member 702 and the split ring is omitted.

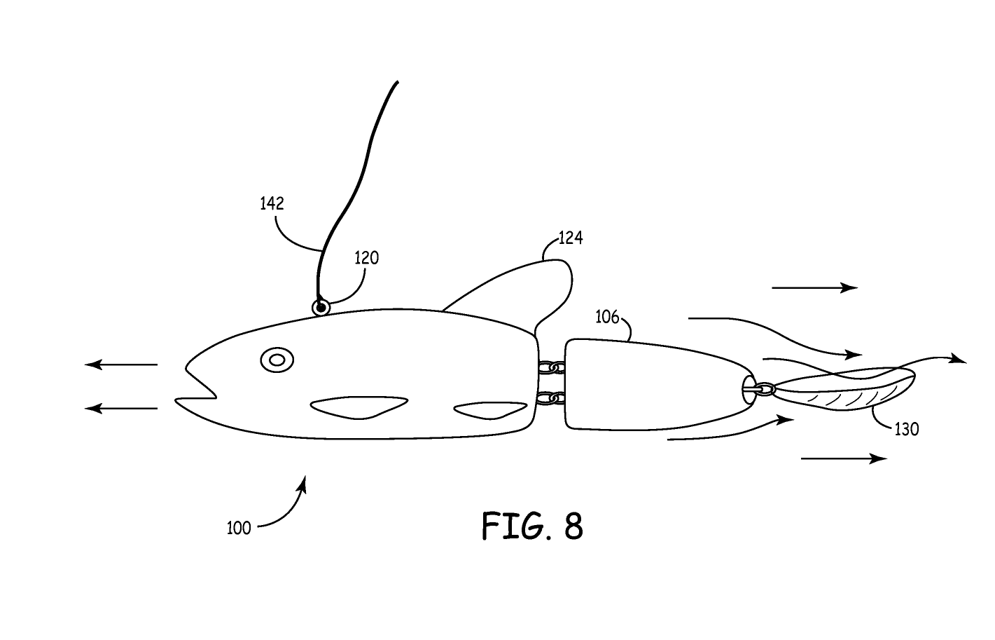

FIG. 8 shows the apparatus 100 coupled to a fishing line 142. The apparatus 100 includes an eye 120 to which the fishing line is tied. The apparatus optionally includes additional eyes 118, 122 that allow for placement of the fishing line in alternate locations on the body. In an example, the position of the apparatus in water relative to horizontal can be selected by selecting a particular eye to which the fishing line is attached. In an example, weights are imbedded or otherwise mounted in or on the body of the apparatus. Typically the weights are mounted about ¼ to ⅓ of the body length from the head. In some examples, weights are also mounted in the tail. In an example, the apparatus moves forward in the water when the apparatus is dropped down in water or pulled up through water.

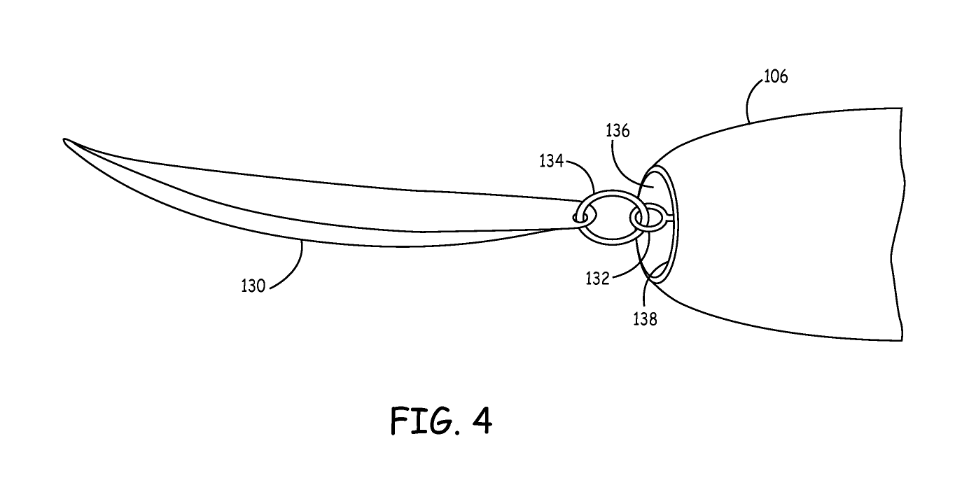

The apparatus 100 optionally also includes a number of fins. In FIG. 4, the apparatus includes a dorsal fin 124, pelvic fins 126, and anal fins 128. The dorsal fin is optionally positionable to allow control of the apparatus in an ice fishing hole. For example, the fin can be angled or otherwise positioned to make the decoy “swim” in a circle in the ice hole. Decoy features such as an eye 128, coloring or texture may also be provided to impart the apparatus with the appearance of a fish.

Referring again to FIG. 8, water flows into and around the spinner blade as the water flows past the apparatus, as indicated by arrows in the figure. It is understood that the water may be moving, the apparatus 100 may be moving forward in the water, or both. The water flowing over and around the spinner blade causes it to rock back and forth. The rocking motion of the spinner blade is transferred through the coupling system to the tail, causing the tail portion 106 to pivot relative to the head portion 104, simulating the swimming action of a fish.

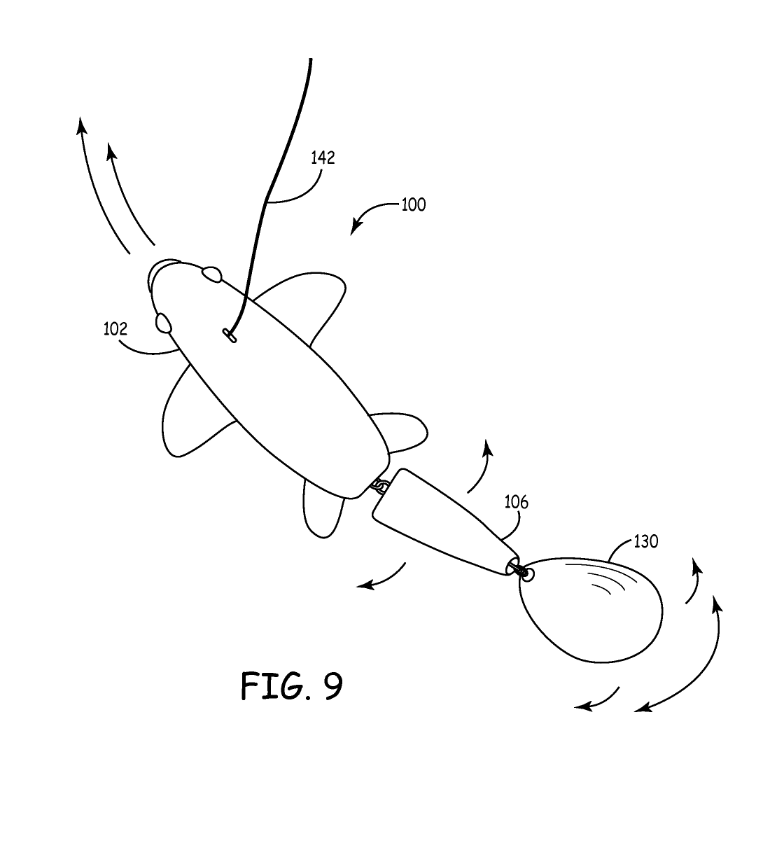

Referring now to the top view shown in FIG. 9, as water flows over the apparatus, the spinner blade 130 moves laterally as shown by arrows. The side-to-side movement of the spinner blade 130 results in a jointed, swimming-like action in the apparatus. The precise action of the apparatus depends upon hydrodynamic factors such as water speed and directions. In most situations, the side-to-side movement of the spinner blade causes the tail portion 106 of the body to move from side-to-side. The head portion 104 may also move from side to side in some examples.

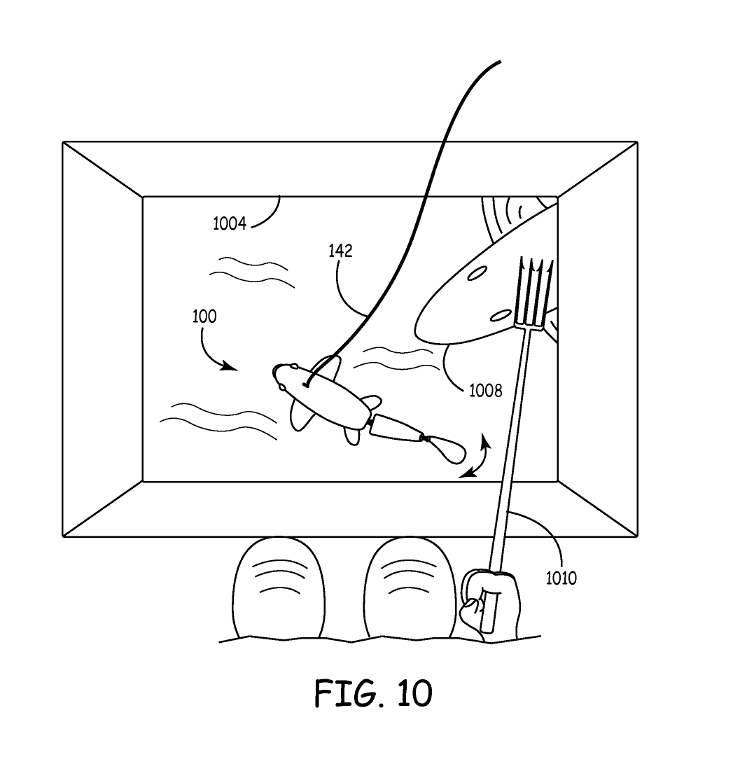

FIG. 10 is a top view of an ice hole showing the apparatus and a fish. The line is manipulated to move the apparatus forward in the water, which causes the spinner blade to rock and causes the apparatus to move in a fish-like swimming action. Fish 1008 is attracted to the movement of the apparatus 100. When the fish comes in range in the hole 1004, it can be speared through the hole using a fishing spear 1010.

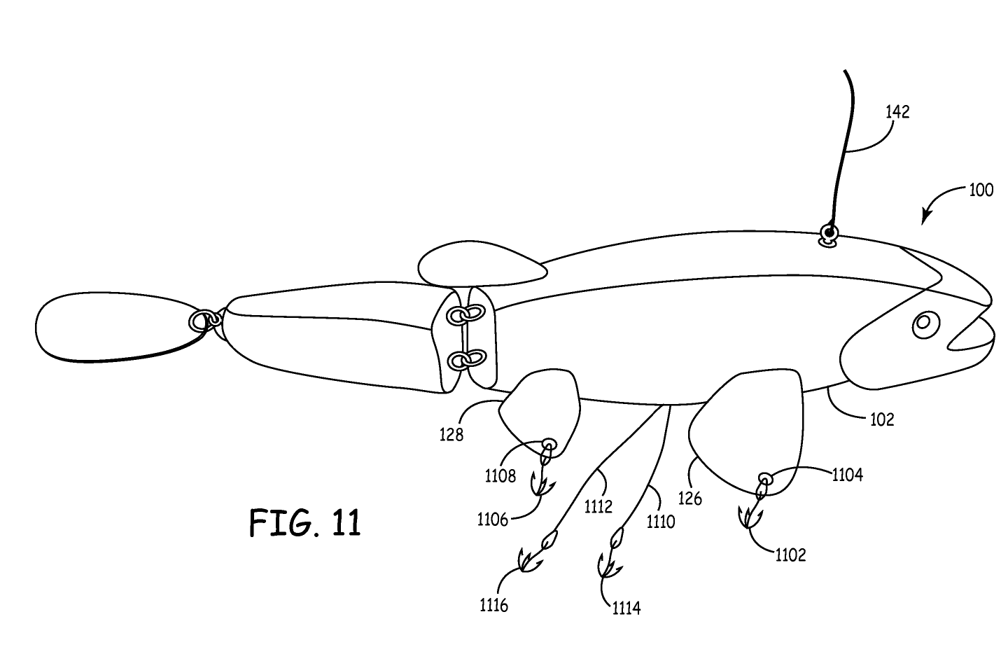

FIG. 11 is a side view that shows an example apparatus 100 that includes fish hooks. In an example, the apparatus 100 can be made into a lure by coupling one or more hooks to the apparatus. In an example, treble hooks 1102, 1106 are coupled to holes 1104, 1108, in fins 126, 128. Alternatively, one or more lines 1110, 1112 are coupled to the body 102 of the apparatus, and a hook 1114, 1116 is coupled to the line.

It is to be understood that the above description is intended to be illustrative, and not restrictive. Because many embodiments of the invention can be made without departing from the scope of the invention, the invention resides in the claims hereinafter appended.

What is claimed is:

1. A fishing apparatus comprising:
a front portion;
a rear portion pivotably coupled to front portion; and
a trailing cup-shaped member pivotably coupled to the rear portion and rotationally restricted relative to the rear portion, wherein movement of water over the cup-shaped member causes the cup-shaped member to rock side-to-side and causes the rear portion to pivot relative to the front portion of the fishing apparatus.

2. The fishing apparatus of claim 1, wherein the rear portion includes portions defining a hole and the apparatus includes a ring extending through the hole, the ring coupled to the trailing cup-shaped member.

3. The fishing apparatus of claim 2, wherein the rear portion includes a screw eye which defines the hole through which the ring extends.

4. The fishing apparatus of claim 3, wherein the rear portion includes portions defining a recession, the screw eye positioned in the recession.

5. The fishing apparatus of claim 4, wherein the trailing cup-shape member is rotatable about 90 degrees clockwise and counter-clockwise from a neutral position relative to the rear portion.

6. The fishing apparatus of claim 1, wherein the trailing cup-shaped member is a deep-cup spinner blade.

7. The fishing apparatus of claim 1, wherein the front portion and rear portion together simulate the appearance of a fish.

8. The fishing apparatus of claim 7, wherein pulling upward or releasing downward of a line coupled to the apparatus results in forward movement of the fishing apparatus through water and lateral rocking of the trailing cup-shaped member which causes lateral pivoting of the rear portion relative to the front portion to simulate the movement of a fish.

9. The fishing apparatus of claim 1, wherein a front-to-rear length of the trailing cup-shaped member is about 20-25% of the sum of the front-to-rear lengths of the front portion and the rear portion.

10. A fishing apparatus comprising:
a jointed decoy body;
a coupling member coupled to the decoy body;
a spinner blade coupled to the coupling member in a manner that allows the spinner blade to rock axially relative to the decoy body but does not allow full rotation of the spinner blade.

11. The fishing apparatus of claim 10, wherein the coupling member is a staple, a screw eye, a wire, or a molded portion of the decoy body.

12. The fishing apparatus of claim 10, wherein the spinner blade is coupled to an interconnecting member that is coupled to the coupling member.

13. The fishing apparatus of claim 12, wherein the interconnecting member is a split ring or a looped wire.

14. The apparatus of claim 10, wherein the spinner blade includes portions defining an upwardly-facing concave cup.

15. The apparatus of claim 10, wherein the decoy body includes portions defining a recession, the coupling member is a screw eye positioned in the recession and configured horizontal relative to the decoy body, the apparatus further comprising a ring extending through the screw eye and through an opening in the spinner blade.

16. The apparatus of claim 10, further comprising at least one hook coupled to the decoy body, wherein the decoy body and hook form a fishing lure.

17. A fish decoy comprising:
a head portion;
a tail portion pivotably coupled to the head portion;
an eye connected to the tail portion;
a deep-cup spinner blade;
a ring extending through the eye and through the spinner blade;
wherein when the fish decoy is moved through water, the spinner blade rocks back and forth, causing the tail portion to pivot relative to the head portion to simulate the swimming action of a fish.

18. The fish decoy of claim 17, wherein the tail portion includes a recession, the eye is mounted in the recession.

19. The fish decoy of claim 18, wherein the decoy further comprises a cup washer mounted in the recession.

20. The fish decoy of claim 19, wherein the eye is a screw eye that is screwed through a hole in the cup washer.
